(19) United States
(12) Patent Application Publication
(10) Pub. No.: US 2026/0352764 A1
(43) Pub. Date: Nov. 5, 2026

(54) System and Method for Capturing User Consent and Identity Through Telecommunications Channels

(71) Applicant: TapText llc, Coral Springs, FL (US)

(72) Inventors: Steve Doumar, Fort Lauderdale, FL (US); David Teodosio, Guilford, CT (US); Brian Galvin, Silverdale, WA (US); Nick Kennedy, Akron, OH (US)

(21) Appl. No.: 19/738,769

(22) Filed: Jul. 13, 2026

Related U.S. Application Data
(63) Continuation-in-part of application No. 19/683,929, filed on May 21, 2026.
Application No. 19/683,929 is a continuation-in-part of application No. 19/441,824, filed on Jan. 6, 2026.
Application No. 19/441,824 is a continuation of application No. 17/874,209, filed on Jul. 26, 2022, now Pat. No. 12,519,888.
Application No. 17/874,209 is a continuation-in-part of application No. 17/865,814, filed on Jul. 15, 2022, now Pat. No. 12,211,070.
Application No. 17/865,814 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
(60) Provisional application No. 63/154,357, filed on Feb. 26, 2021.
(60) Provisional application No. 63/166,391, filed on Mar. 26, 2021.
(60) Provisional application No. 64/044,897, filed on Apr. 20, 2026.

(51) Int. Cl. H04M 3/51; H04L 51/02; H04M 1/72436

(52) U.S. Cl. CPC H04M 3/5191; H04L 51/02; H04M 1/72436

(57) ABSTRACT

A system and method for capturing user consent and identity through telecommunications channels resolves that identity against external transaction systems and enables a continuous, bidirectional data loop powering real-time, AI-driven personalized messaging. A persistent user identity profile anchored to a telecommunications identifier is maintained by an interaction control server. An event ingestion engine receives identity-linked activity signals from external transaction systems and normalizes them to a canonical schema. A matchback processor associates each signal with the telecommunications identifier using deterministic and probabilistic matching. An artificial intelligence decisioning engine determines and dispatches a personalized messaging action in response to each matched signal. A predictive consumption module infers per-user product depletion windows and autonomously triggers replenishment messaging. An active analytics interface classifies user behavioral states and emits predictive triggers to the decisioning engine. A feedback loop module propagates observed outcomes into the identity profile and decisioning models, completing the loop.

### CROSS-REFERENCE TO RELATED APPLICATIONS

Priority is claimed in the application data sheet to the following patents or patent applications, each of which is expressly incorporated herein by reference in its entirety:
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
64/044,897

### BACKGROUND OF THE INVENTION

### Field of the Art

The disclosure relates to the field of computer-based communication systems, more particularly to the field of marketing and promotions using computer-based communication systems.

### Discussion of the State of the Art

Modern customer engagement workflows operate across two largely disconnected technology stacks. On one side is a telecommunications messaging stack comprising Short Message Service (SMS), Multimedia Messaging Service (MMS), and Rich Communication Services (RCS), together with opt-in management tools and messaging automation platforms. On the other side is a transaction stack comprising point-of-sale (POS) systems, customer data platforms (CDPs), customer relationship management (CRM) systems, loyalty management systems, and data warehouses into which transaction records are ingested and enriched. Although each of these stacks has matured considerably, the interface between them remains structurally deficient.

Existing integrations between messaging platforms and transaction systems typically rely on scheduled batch transfers operating on cycles of hours or days, on manually triggered exports, or on loosely coupled analytic pipelines that deliver aggregated reports rather than individual, actionable, user-level events. As a result, a customer who makes a purchase, redeems a loyalty reward, or abandons a shopping cart does not, in contemporary systems, trigger an immediate, personalized, identity-matched outbound messaging action over a telecommunications channel. The observation of that behavior is instead delayed, aggregated, and acted upon only after a latency unsuitable for in-session or consumption-cycle-relevant engagement.

Existing identity resolution mechanisms that attempt to bridge the telecommunications stack and the transaction stack rely predominantly on ephemeral or degrading identifiers, including browser cookies, mobile advertising identifiers, and device fingerprints. These identifiers are increasingly fragile due to browser privacy changes, mobile operating system opt-out frameworks, and evolving regulatory constraints. The net effect is that even where a system is notionally capable of matching transaction events to a messaging-side user profile, the confidence and coverage of such matching are declining over time. A telecommunications identifier such as a phone number, by contrast, represents a persistent, deterministic anchor that does not degrade across sessions, devices, or regulatory changes.

Analytics and reporting components within existing marketing and customer engagement systems are, almost without exception, passive. Dashboards visualize aggregated transaction and messaging data but do not autonomously cause downstream messaging actions to occur on the basis of the behavioral states they reveal. When a dashboard indicates that a user is approaching a predicted replenishment window or has entered an at-risk lapsed state, generating a corresponding outbound message requires human interpretation, manual campaign configuration, and separate workflow initiation. The interval between observation and action in existing systems is measured in days or weeks rather than seconds or minutes.

A further deficiency in existing systems is the absence of integrated consumption-cycle inference tied to a telecommunications identity. Consumable products, refillable prescriptions, and recurring services exhibit characteristic depletion or renewal cadences, yet existing systems do not, in the general case, infer per-user depletion windows from observed transaction histories, tie those windows to a persistent telecommunications identifier, and autonomously trigger a corresponding telecommunications-channel message. What is needed is a system in which transaction events are ingested in near-real-time, matched deterministically or probabilistically to a persistent telecommunications identifier, routed into an AI-driven decisioning engine, acted upon through personalized outbound messaging, and fed back into a continuous closed loop that improves with each interaction.

What is needed is a system and method for capturing user consent and identity through telecommunications channels that resolves captured identity against external transaction systems in near-real-time, enabling a continuous, closed-loop coupling between observed transaction behavior and personalized outbound messaging. Such a system would ingest transaction events as they occur, match them deterministically or probabilistically to a persistent telecommunications identifier, route matched events into an AI-driven decisioning engine, and dispatch personalized messaging actions without batch delays or human intervention. The system would further infer per-user consumption and depletion cycles to trigger proactive replenishment messaging, classify user behavioral states through an active analytics interface that autonomously drives engagement rather than merely reporting on it, and propagate all observed messaging and transaction outcomes back into a continuously improving identity profile and decisioning model—thereby eliminating the fragmentation, latency, and passivity that characterize existing customer engagement systems.

### SUMMARY OF THE INVENTION

Accordingly, the inventor has conceived and reduced to practice a system and method for capturing user consent and identity through telecommunications channels, resolving that identity against external transaction systems in near-real-time, and enabling a continuous, bidirectional data loop through which observed transaction behavior automatically and continuously informs outbound personalized messaging over a telecommunications channel, and through which observed messaging interactions and subsequent transaction behavior automatically and continuously refine the system's understanding of, and future engagement with, the identified user. The following description sets forth the architectural and operational details of such a system, beginning with the manner in which user consent and telecommunications identity are captured, proceeding through the mechanisms by which that identity is resolved against external transaction systems and matched to incoming activity signals, and concluding with the decisioning, messaging activation, predictive consumption, and feedback loop operations that give rise to the closed-loop character of the invention.

According to another preferred embodiment, system for capturing user consent and identity through telecommunications channels, comprising: an interaction control server configured to: receive a user opt-in interaction via a telecommunications channel; capture a telecommunications identifier associated with the interaction; maintain a persistent user identity profile anchored to the telecommunications identifier; and maintain opt-in state information governing messaging eligibility and transaction-signal-ingestion scope; an event ingestion engine configured to receive one or more identity-linked activity signals from one or more external transaction systems and normalize the received signals into a canonical schema; a matchback processor configured to: associate each received identity-linked activity signal with the telecommunications identifier using one or more of deterministic matching and probabilistic matching; and produce a confidence score for each matched signal; an artificial-intelligence decisioning engine configured to determine, in response to each matched identity-linked activity signal, a messaging action based at least in part on the matched signal, the persistent user identity profile, and the opt-in state; a messaging gateway configured to transmit a personalized message corresponding to the determined messaging action via a selected messaging protocol; and a feedback loop service configured to: capture user interaction with the transmitted message; and update the persistent user identity profile and one or more models of the artificial-intelligence decisioning engine based on the captured interaction and on subsequent identity-linked activity signals; wherein the system operates continuously such that the persistent user identity profile and the parameters governing subsequent messaging actions evolve over time without requiring renewed user-provided identity information.

According to another preferred embodiment, a method for capturing user consent and identity through telecommunications channels, comprising the steps of: receiving a user opt-in interaction via a telecommunications channel, using an interaction control server; capturing a telecommunications identifier associated with the interaction, using an interaction control server; maintaining a persistent user identity profile anchored to the telecommunications identifier, using an interaction control server; maintaining opt-in state information governing messaging eligibility and transaction-signal-ingestion scope, using an interaction control server; receiving one or more identity-linked activity signals from one or more external transaction systems and normalize the received signals into a canonical schema, using an event ingestion engine; associating each received identity-linked activity signal with the telecommunications identifier using one or more of deterministic matching and probabilistic matching, using a matchback processor; producing a confidence score for each matched signal, using a matchback processor; determining, in response to each matched identity-linked activity signal, a messaging action based at least in part on the matched signal, the persistent user identity profile, and the opt-in state, using an artificial-intelligence decisioning engine; transmitting a personalized message corresponding to the determined messaging action via a selected messaging protocol, using a messaging gateway; capturing user interaction with the transmitted message, using a feedback loop service; updating the persistent user identity profile and one or more models of the artificial-intelligence decisioning engine based on the captured interaction and on subsequent identity-linked activity signals, using a feedback loop service; and wherein the system operates continuously such that the persistent user identity profile and the parameters governing subsequent messaging actions evolve over time without requiring renewed user-provided identity information.

### BRIEF DESCRIPTION OF THE DRAWING FIGURES

FIG. 1 is a top-level system diagram of a closed-loop customer engagement system, depicting principal components through which user consent and identity are captured via a telecommunications channel, according to a preferred embodiment.

FIG. 2 is a block diagram illustrating the internal architecture of the event ingestion engine and matchback processor, and their relationship to the external transaction systems, identity graph, and AI decisioning engine.

FIG. 3 is a data structure diagram illustrating the architecture of the identity graph and the canonical schema of the identity-linked activity signal, according to an embodiment.

FIG. 4 is a block diagram illustrating the internal architecture of the AI decisioning engine and its inputs and outputs, according to an embodiment.

FIG. 5 is a block diagram illustrating the internal architecture of the active analytics interface and its relationship to the AI decisioning engine, according to an embodiment.

FIG. 6 is a method flow diagram illustrating the master end-to-end closed-loop method for capturing user consent and identity through a telecommunications channel and continuously engaging the identified user based on observed transaction behavior, according to a preferred embodiment.

FIG. 7 is a block diagram illustrating the internal architecture of the predictive consumption server and its relationship to the AI decisioning engine and feedback loop, according to an embodiment.

FIG. 8 is a method flow diagram illustrating an example end-to-end flow of the closed-loop customer engagement system in a quick-service restaurant context, according to an embodiment.

FIG. 9 illustrates an exemplary computing environment on which an embodiment described herein may be implemented.

### DETAILED DESCRIPTION OF THE INVENTION

The inventors have conceived, and reduced to practice, a system and method for capturing user consent and identity through telecommunications channels, resolving that identity against external transaction systems in near-real-time, and enabling a continuous, bidirectional data loop through which observed transaction behavior automatically and continuously informs outbound personalized messaging over a telecommunications channel, and through which observed messaging interactions and subsequent transaction behavior automatically and continuously refine the system's understanding of, and future engagement with, the identified user. The following description sets forth the architectural and operational details of such a system, beginning with the manner in which user consent and telecommunications identity are captured, proceeding through the mechanisms by which that identity is resolved against external transaction systems and matched to incoming activity signals, and concluding with the decisioning, messaging activation, predictive consumption, and feedback loop operations that give rise to the closed-loop character of the invention.

At the entry point of the system, a user interacts with a digital activation asset—such as a quick-response code displayed at a point of sale, an SMS link, or an RCS entry point—and completes a one-tap opt-in interaction that delivers a telecommunications identifier, typically a phone number, to an interaction control server. The interaction control server captures this identifier together with associated device data and consent scope information, and establishes a persistent user identity profile anchored to the telecommunications identifier. The use of a telecommunications identifier as the primary identity anchor is a foundational design choice of the invention. Unlike browser cookies, mobile advertising identifiers, or device fingerprints, a phone number is persistent across sessions, devices, operating system updates, and regulatory changes, providing a durable and deterministic foundation for identity resolution that does not degrade over time. The opt-in state associated with the telecommunications identifier governs, throughout the lifetime of the user's relationship with the system, which categories of transaction signals may be ingested, which classes of messaging action may be autonomously dispatched, and which downstream destinations may receive enriched identity data, providing a structured and auditable consent surface that operates at an event-category granularity rather than as a binary permission flag.

Once a telecommunications identifier has been captured and a persistent user identity profile established, the system resolves that identifier against one or more external transaction systems—including point-of-sale systems, customer data platforms, customer relationship management systems, loyalty management systems, electronic commerce platforms, subscription billing platforms, and data warehouses—linking the telecommunications identity to any existing records the operator holds for the user within those systems. From that point forward, transaction events observed by any connected external transaction system are delivered to an event ingestion engine, which receives them via webhook, API callback, streaming event subscription, or batch ingestion, and normalizes heterogeneous vendor-specific event formats into a canonical identity-linked activity signal schema. This normalization step is essential to the system's ability to operate across diverse commercial verticals and integration surfaces, ensuring that all downstream matching and decisioning operations proceed against a consistent, well-structured data object regardless of the originating system or event type.

Each normalized identity-linked activity signal is routed to a matchback processor, which associates the signal with the telecommunications identifier anchoring the relevant persistent user identity profile using parallel deterministic and probabilistic matching pipelines. The deterministic pipeline performs exact-match lookups on shared identifiers such as phone number, hashed email address, and loyalty identifier, while the probabilistic pipeline computes match likelihood using device fingerprint, behavioral similarity, temporal-spatial correlation, and session correlation signals. The outputs of both pipelines are combined into a unified confidence score, which is evaluated against a configurable threshold to gate downstream autonomous action. Matched signals clearing the threshold are forwarded to an artificial-intelligence decisioning engine, which determines a messaging action in response, selecting among abstention, immediate dispatch, and scheduled dispatch, and determining message content type, format, and delivery channel through a sequence of functional sub-components including a next-best-action selector, a timing optimizer, a channel selector, a content and format selector, and a confidence threshold gate. The resulting personalized message is transmitted to the user via a messaging gateway supporting Short Message Service, Multimedia Messaging Service, and Rich Communication Services, with channel selection governed by an eligibility service that considers opt-in state, device capabilities, and carrier enablement.

A predictive consumption module extends the event-triggered engagement capability of the system by operating on accumulated histories of identity-linked activity signals to infer, at the product or product-family level, characteristic inter-purchase intervals for individual users. From these inferred cadences, a depletion-window estimator produces projected depletion times and confidence intervals for consumable products and recurring services, and a replenishment-trigger generator emits predictive triggers to the artificial-intelligence decisioning engine at configured lead times before projected depletion. This enables the system to engage users proactively at moments of anticipated need—before a consumable runs out, before a routine service interval elapses, before a subscription lapses—rather than solely in reaction to observed events. A promotional-elasticity modeler within the predictive consumption module further estimates, per user or per cohort, the responsiveness of transaction behavior to prior messaging interactions, supplying elasticity estimates as inputs to the decisioning engine's timing and content selection logic so that the aggressiveness, timing, and incentive level of proactive outreach are calibrated to each user's observed responsiveness.

An active analytics interface aggregates data derived from both identity-linked activity signals and messaging interactions, classifies users into behavioral states including purchase-occurrence, approaching-depletion, offer-responsive, at-risk, and lapsed, and emits predictive triggers to the artificial-intelligence decisioning engine autonomously and independently of any operator-facing dashboard. This architectural arrangement—in which the analytics interface functions as an active input layer to the closed loop rather than a passive visualization tool—is a key distinguishing characteristic of the invention. In existing systems, the interval between the observation of a behavioral state and the dispatch of a corresponding messaging action is gated by human interpretation of dashboard data and manual campaign configuration, introducing latency measured in days or weeks. In the present system, that interval is eliminated: observed behavioral states translate directly and automatically into outbound messaging actions without any human-in-the-loop step, while the operator-facing dashboard continues to render aggregated and classified data in parallel for inspection and configuration purposes without being on the critical path to action.

The feedback loop module completes the closed-loop architecture by capturing user interaction with each transmitted message and propagating observed outcomes—including opens, clicks, conversions, and subsequent identity-linked activity signals received within the applicable attribution window—back into the persistent user identity profile, the matchback processor's confidence model, and the models governing the artificial-intelligence decisioning engine and predictive consumption module. This continuous feedback propagation ensures that the system's understanding of each user, and the precision of its engagement decisions, improve with each completed cycle of transaction observation, matching, decisioning, dispatch, and interaction capture. The persistent user identity profile thus evolves over time as a living representation of the user's transaction behavior, consumption cadences, promotional responsiveness, and messaging engagement patterns, and the parameters governing all subsequent messaging actions are continuously refined on the basis of that evolving profile, without requiring any renewed user-provided identity information or manual operator reconfiguration.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

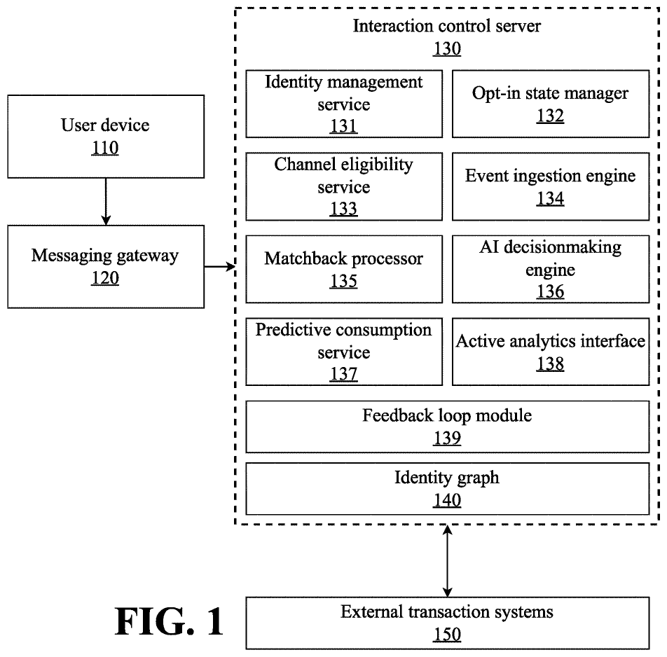

FIG. 1 is a top-level system diagram of a closed-loop customer engagement system, depicting principal components through which user consent and identity are captured via a telecommunications channel, according to a preferred embodiment. The system is organized around a central interaction control server 130 that mediates between a user-facing telecommunications layer on one side and one or more external transaction systems 150 on the other, coordinating all identity management, event ingestion, decisioning, and messaging functions through a set of discrete but interoperating sub-components. This architecture reflects the fundamental design principle of the invention: that a persistent telecommunications identifier, once captured through a consent interaction, can serve as a durable anchor connecting observable transaction behavior to real-time personalized engagement across the full lifecycle of a customer relationship.

The telecommunications-facing layer comprises a user device 110 and a messaging gateway 120. The user device 110 represents any computing device through which a user may interact with a digital activation asset and receive inbound messages via one or more messaging protocols, including Short Message Service, Multimedia Messaging Service, and Rich Communication Services. The messaging gateway 120 is configured to support those messaging protocols, to receive messaging instructions from the interaction control server 130, and to deliver outbound messages to the user device 110 using a selected protocol. Communication between the user device 110 and the messaging gateway 120 is bidirectional, reflecting both the outbound delivery of personalized messages and the inbound capture of user interactions and opt-in events that initiate and sustain the closed loop.

The interaction control server 130 is the operational core of the system and contains, or is in communication with, a set of sub-components each responsible for a distinct functional domain. The identity management service 131 maintains a persistent user identity profile anchored to the telecommunications identifier captured at opt-in, accumulating transaction history, behavioral signals, and messaging interaction data over time without requiring renewed user-provided identity information on each subsequent interaction. The opt-in state manager 132 maintains opt-in state information governing both messaging eligibility and the scope of transaction signal ingestion permitted with respect to the telecommunications identifier, enforcing consent boundaries throughout the system. The channel eligibility service 133 determines, on a per-action basis, which messaging protocol is available and appropriate for a given user and a given messaging action, considering opt-in state, device capabilities, carrier enablement, and business verification status.

The interaction control server 130 further comprises an event ingestion engine 134, a matchback processor 135, an AI decisionmaking engine 136, a predictive consumption service 137, an active analytics interface 138, a feedback loop module 139, and an identity graph 140. The event ingestion engine 134 receives identity-linked activity signals from the external transaction systems 150, normalizing heterogeneous vendor-specific event formats into a canonical schema suitable for downstream matching and decisioning. The matchback processor 135 associates each normalized signal with the telecommunications identifier maintained by the identity management service 131, employing both deterministic matching on shared identifiers such as phone number and loyalty identifier, and probabilistic matching on signals such as device fingerprint and behavioral similarity, producing a confidence-scored match result for each inbound event. The identity graph 140 serves as the persistent data structure underlying the matchback processor 135 and the identity management service 131, linking the primary telecommunications identifier to secondary identifiers and to external system identifiers across all connected transaction systems 150, and being updated in near-real-time as new activity signals are received and matched.

Upon a successful match, the AI decisionmaking engine 136 determines a messaging action in response to the matched signal, drawing on the persistent user identity profile, prior messaging interaction data, and applicable opt-in state to select among abstention, immediate dispatch, and scheduled dispatch, and to determine message content type and delivery channel. The predictive consumption service 137 operates on accumulated histories of identity-linked activity signals to infer per-user product or service depletion windows, emitting predictive triggers to the AI decisionmaking engine 136 at computed lead times before projected depletion so that replenishment or renewal messaging may be dispatched proactively. The active analytics interface 138 aggregates data from both messaging interactions and identity-linked activity signals, classifies users into behavioral states, and emits predictive triggers to the AI decisionmaking engine 136 autonomously and independently of any operator-facing visualization, functioning as an active input layer to the closed loop rather than a passive reporting tool. The feedback loop module 139 captures user interaction with each transmitted message and subsequent identity-linked activity signals received from the external transaction systems 150, propagating observed outcomes back into the identity management service 131, the matchback processor 135, and the AI decisionmaking engine 136, such that the system continuously refines its understanding of each user and improves the precision of subsequent engagement without requiring external reconfiguration.

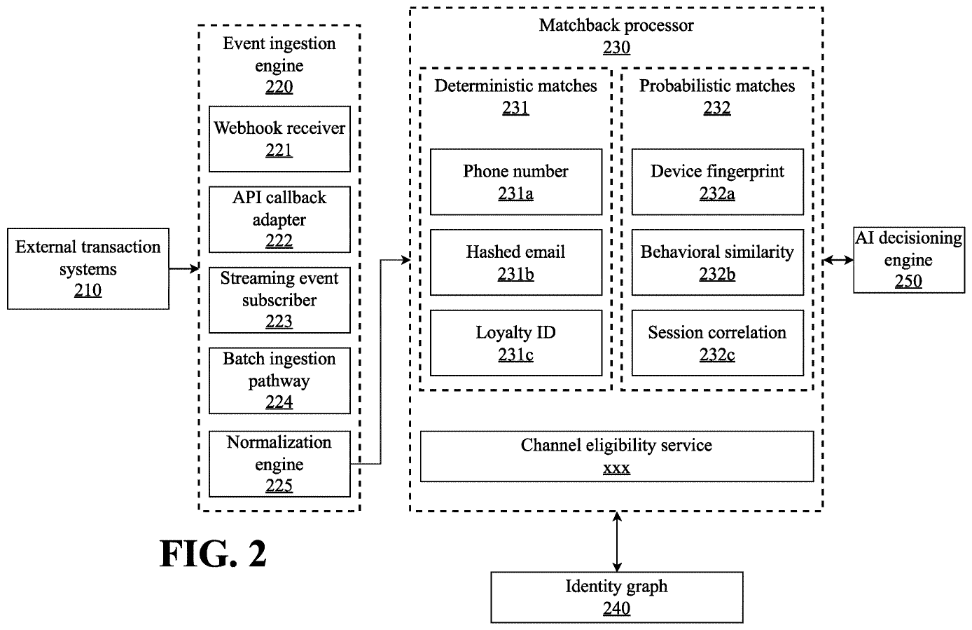

FIG. 2 is a block diagram illustrating the internal architecture of the event ingestion engine 220 and matchback processor 230, and their relationship to the external transaction systems 210, identity graph 240, and AI decisioning engine 250. The event ingestion engine 220 is the entry point through which raw transaction event data from the external transaction systems 210 is received and transformed into normalized signals suitable for identity matching and downstream decisioning. To accommodate the variety of integration surfaces exposed by different external transaction systems 210, the event ingestion engine 220 supports four parallel ingestion modalities. The webhook receiver 221 exposes inbound endpoints to which external transaction systems 210 may post event payloads upon the occurrence of qualifying events. The API callback adapter 222 is configured to invoke callback endpoints exposed by external transaction systems 210 and retrieve event data on schedule or on demand. The streaming event subscriber 223 subscribes to event streams exposed by external transaction systems 210 using low-latency streaming protocols, and is preferred for transaction systems operating at high transaction rates or requiring sub-second matchback latency. The batch ingestion pathway 224 supports retrieval of event data in bulk for external transaction systems lacking real-time integration surfaces, or for reconciliation and replay scenarios. Raw event data received along any of these modalities is routed into the normalization engine 225, which translates heterogeneous, vendor-specific event formats into a canonical identity-linked activity signal schema, consulting vendor-specific format descriptors to ensure consistent structure regardless of the originating system.

The normalized output of the normalization engine 225 flows into the matchback processor 230, which is responsible for associating each incoming signal with a telecommunications identifier and, by extension, with a persistent user identity profile maintained within the identity graph 240. The matchback processor 230 operates two parallel matching pipelines. The deterministic matches pipeline 231 performs exact-match lookups against the identity graph 240 using shared identifiers carried within the signal, including phone number 231a, hashed email 231b, and loyalty ID 231c. Deterministic matches are preferred for their high precision, and a single high-confidence deterministic match is generally sufficient to resolve a signal to a persistent user identity profile. Where no deterministic identifier is available, or as corroboration where deterministic confidence is insufficient, the probabilistic matches pipeline 232 operates in parallel, computing match likelihood using device fingerprint 232a, behavioral similarity 232b, and session correlation 232c. Together, the two pipelines produce a confidence-scored match result for each inbound signal, gating downstream processing against a configurable confidence threshold before forwarding matched signals onward.

Matched signals cleared by the matchback processor 230 are forwarded to the AI decisioning engine 250, which determines an appropriate messaging action in response. The identity graph 240 serves as the shared persistent data structure consulted by the matchback processor 230 throughout the matching process, linking the primary telecommunications identifier to secondary identifiers and external system identifiers, and being updated in near-real-time as new signals are received and matched. The channel eligibility service 133 is referenced in the context of the matchback processor 230 and AI decisioning engine 250 to reflect that protocol selection for any resulting messaging action is governed by eligibility determinations made at the time of dispatch, ensuring that matched events are acted upon only through channels consistent with the user's opt-in state and device capabilities.

According to another embodiment, the matchback processor is configured to produce confidence scores through a plurality of alternative confidence-scoring strategies, each strategy characterized by distinct computational approaches and calibrated to different matching scenarios and data availability conditions. In a first embodiment, the matchback processor employs a weighted-sum confidence scorer that computes a linear combination of normalized match-strength signals drawn from the deterministic and probabilistic matching pipelines, with weights assigned to each signal type based on empirically observed precision and recall characteristics. The weighted-sum confidence scorer assigns high weights to exact-match deterministic signals such as telephone number match and hashed email match, moderate weights to strong probabilistic signals such as device fingerprint match with high similarity score and behavioral similarity with statistically significant correlation, and low weights to weak probabilistic signals such as coarse geographic proximity or general demographic alignment. The weighted-sum approach provides computational efficiency and interpretability, and is particularly suitable for high-throughput matching scenarios where sub-second latency is required.

In a second embodiment, the matchback processor employs a machine-learning-classifier confidence scorer that accepts as inputs a feature vector comprising all available deterministic and probabilistic match signals together with contextual features such as time-since-last-interaction, transaction frequency, and signal source system, and produces as output a predicted probability that the inbound identity-linked activity signal corresponds to the candidate persistent user identity profile. The machine-learning-classifier confidence scorer may be implemented as a gradient-boosted decision tree ensemble, a logistic regression model, a neural network classifier, or any other supervised learning architecture, and is trained on historical match outcomes labeled through subsequent deterministic confirmation, manual review, or cross-validation against ground-truth linkage data. The machine-learning-classifier approach provides superior accuracy in complex matching scenarios involving partial or noisy identifier data, at the cost of increased computational overhead and reduced interpretability relative to the weighted-sum approach.

In a third embodiment, the matchback processor employs a Bayesian-likelihood-ratio confidence scorer that computes, for each candidate persistent user identity profile, the ratio of the likelihood that the observed match signals would be generated if the candidate profile is the true match to the likelihood that the observed match signals would be generated if the candidate profile is not the true match, and converts the resulting likelihood ratio to a posterior probability through application of Bayes' theorem with empirically derived prior probabilities of match and non-match. The Bayesian-likelihood-ratio approach provides a principled probabilistic framework for combining evidence from heterogeneous signal types with differing error characteristics, and is particularly suitable for matching scenarios in which interpretable uncertainty quantification is required for downstream decisioning or auditing purposes.

According to another embodiment, the matchback processor is configured to resolve ambiguous matching scenarios in which multiple candidate persistent user identity profiles produce confidence scores above the applicable threshold, indicating that the inbound identity-linked activity signal could plausibly be matched to more than one user. In such scenarios, the matchback processor applies a minimum-margin-over-second-highest-candidate rule in which the identity-linked activity signal is matched to the highest-scoring candidate profile only if the confidence score of the highest-scoring candidate exceeds the confidence score of the second-highest-scoring candidate by at least a configurable minimum margin. If the margin condition is satisfied, the signal is matched to the highest-scoring candidate and proceeds to downstream decisioning with the original confidence score. If the margin condition is not satisfied, indicating that the match is genuinely ambiguous between two or more candidates, the matchback processor may apply one of several conflict-resolution strategies: deferring the match pending receipt of additional corroborating signals that disambiguate the candidates; routing the ambiguous match to a manual review queue for operator resolution; or discarding the match entirely and logging the ambiguous signal for subsequent batch reconciliation. The minimum-margin rule prevents false-positive matches in scenarios where identifier reuse, household sharing of devices, or data quality issues in external transaction systems create structurally ambiguous matching evidence, and ensures that downstream autonomous messaging actions are dispatched only when match confidence genuinely exceeds the applicable threshold with adequate separation from alternative match hypotheses.

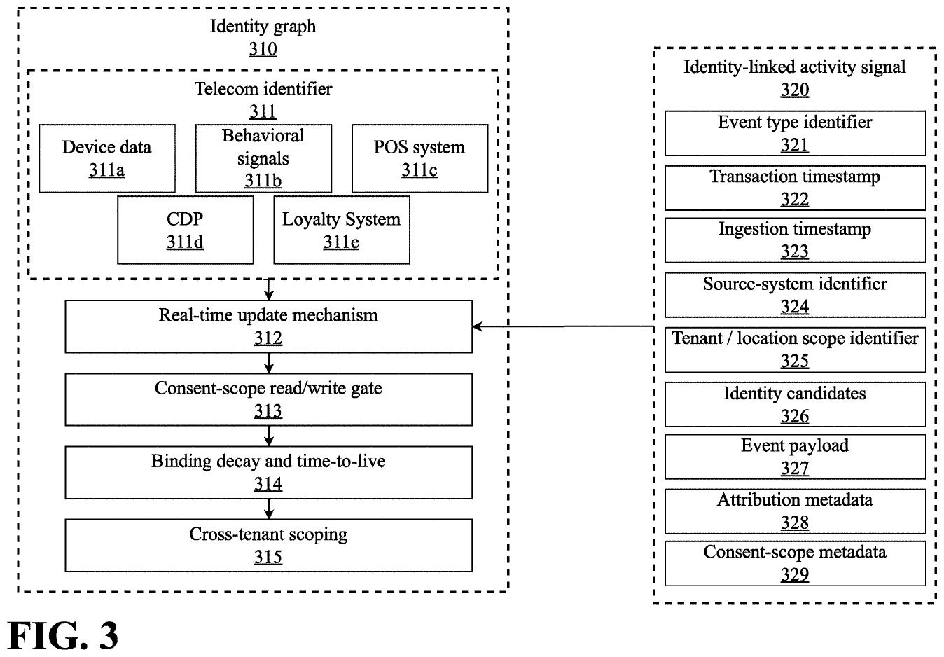

FIG. 3 is a data structure diagram illustrating the architecture of the identity graph and the canonical schema of the identity-linked activity signal, according to an embodiment. Together, these two structures form the data foundation upon which the matchback, decisioning, and feedback operations of the system depend, with the identity-linked activity signal serving as the normalized representation of an observed transaction event and the identity graph serving as the persistent record against which that signal is resolved.

The identity graph 310 is centered on a telecom identifier 311, which serves as the primary anchor of the persistent user identity profile and provides a durable, deterministic foundation that does not degrade across sessions, devices, or regulatory changes in the manner of cookie-or device-based identifiers. Radiating from the telecom identifier 311 are secondary identifier nodes representing device data 311a and behavioral signals 311b, which accumulate over time as the user interacts with the system through messaging channels and activation assets. The identity graph 310 further maintains edges to external system identifier nodes representing a POS system 311c, a CDP 311d, and a loyalty system 311e, linking the primary telecommunications identifier to the user's corresponding records within each connected external transaction system and enabling deterministic or probabilistic resolution of inbound activity signals to the persistent user identity profile.

The identity graph 310 comprises several operational mechanisms that govern how it is maintained and accessed. The real-time update mechanism 312 is configured to apply mutation operations to the identity graph 310 in response to matched identity-linked activity signals, creating new edges when previously unknown external system identifiers are observed, updating edge confidence values as additional matching evidence accumulates, and inserting behavioral signal nodes representing newly observed event patterns. The consent-scope read/write gate 313 enforces opt-in scope restrictions on both mutation and query operations against the identity graph 310, consulting the opt-in state manager to ensure that only data categories within the applicable consent scope are read from or written to the graph, with audit records generated for each suppressed operation. The binding decay and time-to-live mechanism 314 applies configurable decay functions to probabilistic binding edges within the identity graph 310, such that probabilistic associations age out over time absent corroborating observation while deterministic identifier edges persist subject only to explicit removal. The cross-tenant scoping module 315 maintains appropriate separation of identity data across distinct merchant operators while supporting shared identity resolution across multiple locations or business units affiliated with a common operator, such that activity signals originating at any affiliated location are resolved to a single persistent user identity profile scoped to that operator.

The identity-linked activity signal 320 is the canonical data object by which observable transaction events are represented within the system after normalization and prior to matchback. Each identity-linked activity signal 320 comprises a set of structured fields carrying the information necessary for matching, decisioning, and attribution. The event type identifier 321 classifies the nature of the observed event, drawn from a taxonomy including purchase, return, cart abandonment, loyalty enrollment, and related event categories. The transaction timestamp 322 records the time at which the underlying event occurred within the external transaction system, while the ingestion timestamp 323 records the time at which the normalized signal entered the event ingestion engine, the difference between the two providing a measurable ingestion latency for operational monitoring. The source-system identifier 324 identifies the external transaction system from which the signal originated, and the tenant or location scope identifier 325 indicates the specific merchant, franchise location, or storefront to which the signal pertains. The identity candidates 326 carry one or more field-value pairs suitable for matchback, including telephone number, hashed email address, loyalty identifier, and device fingerprint. The event payload 327 contains the substantive content of the event, including line-item data, aggregate transaction amounts, promotional modifiers applied, and channel-of-purchase indicators. The attribution metadata 328 carries campaign identifiers, referral tokens, and promotion codes that enable downstream attribution of messaging interactions to observed transaction outcomes. The consent-scope metadata 329 indicates any restrictions on use of the signal derived from the originating system's own consent framework, ensuring that downstream processing respects the full applicable consent surface associated with the signal.

According to another embodiment, the event ingestion engine and matchback processor are configured to operate within a configurable latency budget that governs the maximum acceptable elapsed time from receipt of a raw transaction event at an external transaction system to completion of matching and forwarding of the matched identity-linked activity signal to the artificial-intelligence decisioning engine. The latency budget is established to ensure that the system can dispatch autonomous messaging actions while triggering events remain contextually relevant and while users remain in states receptive to engagement. In a preferred embodiment, the matchback latency budget is set at a range of hundreds of milliseconds to a few seconds for in-visit or in-session transaction events where immediate engagement is desired, and at a range of several seconds to tens of seconds for post-visit or asynchronous transaction events where modest additional latency is acceptable. The latency budget may be configured globally, per vertical, per external transaction system, or per signal type, reflecting the distinct engagement-window characteristics of different transaction contexts. By way of example, a point-of-sale transaction at a quick-service restaurant location may be associated with a latency budget of one to three seconds to enable in-visit cross-sell messaging while the customer remains on premises, while an e-commerce cart-abandonment event may be associated with a latency budget of ten to thirty seconds reflecting the longer temporal window during which recovery messaging remains effective.

The event ingestion engine and matchback processor are architected to meet the applicable latency budget through parallel processing, in-memory data structures, and priority-based routing. The webhook receiver and streaming event subscriber modalities of the event ingestion engine provide sub-second event delivery from external transaction systems to the normalization engine, and the normalization engine operates as a stateless transformation that introduces minimal additional latency. The matchback processor maintains the identity graph in a high-performance in-memory data store optimized for low-latency lookups, with deterministic matching queries resolved via indexed exact-match lookups completing in single-digit milliseconds and probabilistic matching queries resolved via approximate nearest-neighbor search or precomputed similarity indices completing in tens of milliseconds. The deterministic and probabilistic matching pipelines operate in parallel such that total matching latency is bounded by the slower of the two pipelines rather than by their sum, and match results clearing the confidence threshold are forwarded to the artificial-intelligence decisioning engine immediately upon confidence score computation without waiting for completion of lower-priority background operations such as identity graph updates or audit logging.

According to another embodiment, in-visit signals identified by the presence of location or point-of-sale context indicators in the identity-linked activity signal are accorded priority routing through the event ingestion engine and matchback processor, preempting or deferring processing of lower-priority post-visit or batch-ingested signals when processing resources are constrained. This priority-based routing ensures that the latency budget for time-sensitive in-visit signals is preserved even during periods of high aggregate transaction volume, at the acceptable cost of modest additional latency for signals associated with longer engagement windows. The system may be configured to monitor and report end-to-end latency distributions for each signal type and external transaction system, enabling operators to identify integration or processing bottlenecks and to adjust latency budgets or priority assignments in response to observed performance characteristics.

According to another embodiment, the opt-in state manager is configured to enforce consent-scope restrictions at two architectural boundaries within the system: an ingestion boundary at the event ingestion engine, and a dispatch boundary at the messaging gateway. At the ingestion boundary, the event ingestion engine consults the opt-in state manager to determine whether the event type and source system of each inbound raw transaction event fall within the transaction-signal-ingestion scope consented to by the user associated with the event. Identity-linked activity signals corresponding to event types or source systems outside the applicable ingestion scope are suppressed at the ingestion boundary and are not normalized, matched, or persisted, ensuring that the system does not accumulate data beyond the scope of the user's consent. At the dispatch boundary, the messaging gateway consults the opt-in state manager to determine whether the messaging action type, content category, and channel of each outbound message fall within the messaging eligibility scope consented to by the user. Messaging actions corresponding to action types, content categories, or channels outside the applicable dispatch scope are suppressed at the dispatch boundary and are not transmitted, ensuring that the system does not engage users through channels or with content beyond the scope of the user's consent.

The two-boundary consent-scope enforcement architecture ensures that consent restrictions are applied both to the ingestion of observable transaction signals and to the dispatch of resulting messaging actions, providing defense in depth against both over-ingestion of user data and over-dispatch of user-facing messaging. The opt-in state manager maintains a unified, canonicalized representation of the user's consent state that is consulted at both boundaries, ensuring consistency of consent interpretation across the ingestion and dispatch operations. Each suppression operation at either boundary is logged to an audit trail maintained by the opt-in state manager, recording the suppressed signal or action together with the applicable consent-scope rule that triggered the suppression, the timestamp of the suppression decision, and a reference to the authoritative consent record. This audit trail provides evidentiary support for regulatory compliance and enables operators to monitor the operational impact of consent-scope restrictions on system throughput and engagement coverage.

The consent-scope read/write gate described in connection with FIG. 3 operates in coordination with the two-boundary enforcement architecture, applying consent-scope restrictions to mutation and query operations against the identity graph itself such that even internal data structures honor the boundaries of the user's consent. Together, the ingestion-boundary enforcement, the dispatch-boundary enforcement, and the identity-graph-level enforcement provide a comprehensive, architecturally integrated consent governance framework that operates continuously and automatically throughout the system without requiring human-in-the-loop review or approval of individual ingestion or dispatch decisions, and that ensures that all observable transaction signals and all resulting messaging actions remain within the scope of the user's explicitly provided, granularly specified, and continuously enforceable consent state.

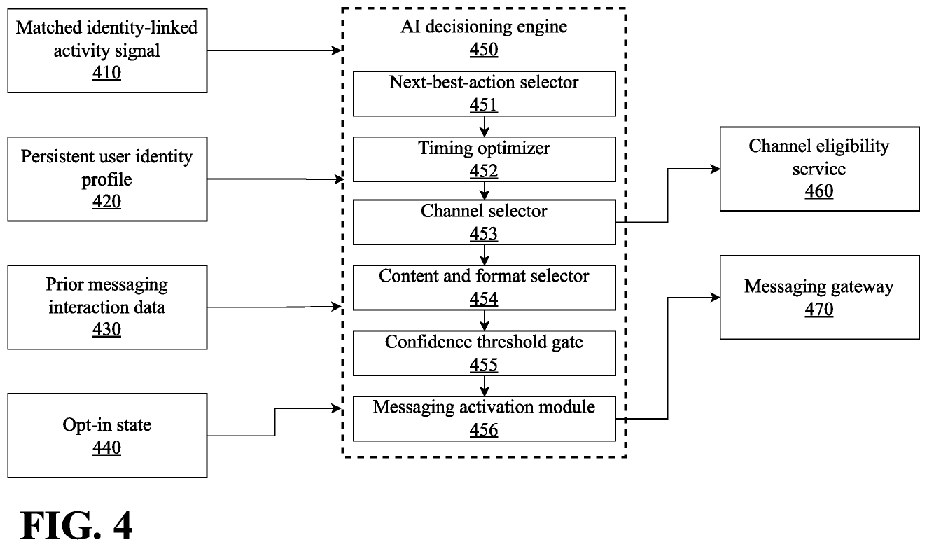

FIG. 4 is a block diagram illustrating the internal architecture of the AI decisioning engine and its inputs and outputs, according to an embodiment. The AI decisioning engine 450 is the component through which matched transaction events are translated into concrete personalized messaging actions, drawing on a combination of real-time signal data, accumulated user history, and applicable consent state to determine, on a per-event basis, whether and how to engage a given user at a given moment. The engine 450 accepts four categories of input: the matched identity-linked activity signal 410, representing the normalized and identity-resolved transaction event that has triggered the current decisioning cycle; the persistent user identity profile 420, containing the accumulated history of prior transactions, messaging interactions, inferred preferences, and behavioral signals associated with the telecommunications identifier; prior messaging interaction data 430, reflecting the user's engagement history with previously transmitted messages including opens, clicks, conversions, and non-responses; and the opt-in state 440, which governs both the categories of messaging action that may be autonomously dispatched and the content types and channels that are permissible within the applicable consent scope.

Within the AI decisioning engine 450, processing proceeds through a sequence of functional sub-components. The next-best-action selector 451 considers the full set of inputs and determines among candidate actions including abstention, immediate dispatch, scheduled dispatch, and escalation to a downstream destination, selecting the action most likely to produce a favorable outcome given the user's current behavioral state and history. The timing optimizer 452 determines, for selected dispatch actions, an optimal transmission time, incorporating inferred user time-of-day preferences, freshness requirements associated with the triggering event, applicable quiet-hours constraints, and cooldown intervals since the most recent prior message. The channel selector 453 determines the preferred messaging protocol for the action, delegating to the channel eligibility service 460 which applies opt-in state evaluation, device capability negotiation, carrier enablement, and business verification status to produce a protocol selection. The content and format selector 454 determines the message content and presentational format, drawing on the event payload of the triggering matched identity-linked activity signal 410, user preferences inferred from the persistent user identity profile 420, and format capabilities returned by the channel eligibility service 460. The confidence threshold gate 455 applies a final confidence check before autonomous dispatch, combining match confidence, action selection confidence, and content appropriateness confidence, routing actions that clear the threshold to the messaging activation module 456 and deferring or discarding those that do not.

The next-best-action selector 451 and timing optimizer 452 are designed to operate in concert, such that the selection of an action type and the determination of its optimal dispatch time are treated as interdependent decisions rather than sequential independent ones. For in-session or in-visit events such as a completed point-of-sale transaction, the timing optimizer 452 may determine that immediate dispatch is appropriate, while for predictive replenishment triggers or at-risk re-engagement actions, a future scheduled dispatch time computed from inferred behavioral cadences may be preferred. In various embodiments, the next-best-action selector 451 is implemented as a machine learning model, a rules engine, a predictive scoring function, or an ensemble of the foregoing, and is continuously updated by outcomes propagated through the feedback loop module, such that the quality of action selection improves over time as the system accumulates attribution data linking prior dispatch decisions to observed downstream transaction behavior.

The content and format selector 454 supports a range of message content types including personalized offers, digital coupons, wallet passes, trackable links, product recommendations, cross-sell prompts, replenishment reminders, loyalty-tier notifications, post-purchase acknowledgments, abandoned-cart recovery prompts, and return or refund follow-ups. Where the channel eligibility service 460 determines that Rich Communication Services is available, the content and format selector 454 may assemble rich cards, carousels, embedded video content, suggested replies, interactive buttons, and branded sender identity as format options. Where Rich Communication Services is unavailable, the channel eligibility service 460 directs fallback to Short Message Service while preserving session continuity and attribution across the protocol transition, ensuring that the messaging activation module 456 and messaging gateway 470 can complete dispatch regardless of the protocol ultimately selected.

The messaging activation module 456 causes the messaging gateway 470 to transmit a personalized message corresponding to the determined messaging action via the protocol selected by the channel eligibility service 460. The messaging gateway 470 delivers the message to the user device using the selected protocol, completing the outbound leg of the closed loop for that decisioning cycle. The channel eligibility service 460 thus functions as a shared dependency between the channel selector 453 and the messaging activation module 456, ensuring that protocol selection and message delivery remain consistent with the user's opt-in state and device capabilities throughout the dispatch process. Interactions captured by the messaging gateway 470 following dispatch are returned to the feedback loop module, where they are attributed against the triggering matched identity-linked activity signal 410 and propagated into updates to the persistent user identity profile 420 and the models governing subsequent operation of the AI decisioning engine 450.

According to another embodiment, the artificial-intelligence decisioning engine comprises a transaction-triggered dispatch pathway configured to route matched identity-linked activity signals into discrete message-class handlers, each handler specialized for a distinct category of engagement action. In a preferred embodiment, the artificial-intelligence decisioning engine comprises five principal message-class handlers operating as semi-autonomous decisioning units within the next-best-action selector: a post-purchase engagement handler, a cross-sell and loyalty handler, a replenishment-reminder handler, an abandoned-cart recovery handler, and a return-and-refund follow-up handler.

The post-purchase engagement handler is invoked in response to purchase-completed identity-linked activity signals and is configured to determine messaging actions that acknowledge the completed transaction, provide transaction-specific information such as order confirmation details or digital receipts, and initiate relationship-building sequences appropriate to the user's lifecycle stage. The cross-sell and loyalty handler is invoked in response to purchase-completed or loyalty-event identity-linked activity signals and is configured to determine messaging actions that present complementary products or services predicted to be of interest given the line-item content of the triggering transaction and the accumulated purchase history maintained in the persistent user identity profile, drawing on product-affinity models and collaborative filtering to identify candidate cross-sell items.

The replenishment-reminder handler is invoked in response to predictive triggers emitted by the predictive consumption module when a user approaches a projected depletion window for a previously purchased consumable product or a renewal window for a previously purchased service, and is configured to determine messaging actions that proactively remind the user of the approaching need and present replenishment options including reorder links or in-store purchasing prompts. The abandoned-cart recovery handler is invoked in response to cart-abandonment or session-timeout identity-linked activity signals and is configured to determine messaging actions that present the user with the content of the abandoned cart and provide a frictionless return path to complete the interrupted transaction. The return-and-refund follow-up handler is invoked in response to return-initiated or refund-completed identity-linked activity signals and is configured to determine messaging actions that acknowledge the return or refund, provide transaction-specific information such as refund status and expected timing, and optionally present alternative product recommendations or service recovery actions.

Each message-class handler accepts as inputs the matched identity-linked activity signal that triggered its invocation together with the persistent user identity profile and the applicable opt-in state, and produces as output a selected messaging action together with recommended timing, channel, content type, and confidence score. The transaction-triggered dispatch pathway routes the output of the selected message-class handler to the timing optimizer, channel selector, and content and format selector for final assembly and dispatch, such that the message-class handler determines the strategic character of the engagement while the shared optimization components determine the tactical execution details. This architectural separation enables the system to maintain specialized engagement logic for each message class while ensuring consistent application of timing, channel, and content optimization across all classes, and provides a natural extension point for the addition of new message classes as new transaction event types become observable through connected external transaction systems.

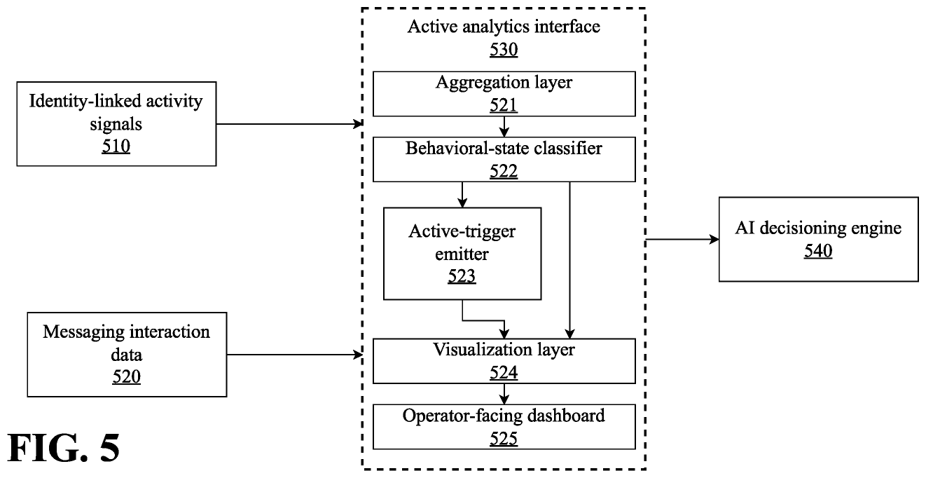

FIG. 5 is a block diagram illustrating the internal architecture of the active analytics interface and its relationship to the AI decisioning engine, according to an embodiment. The active analytics interface 530 represents a fundamental departure from conventional analytics components in customer engagement systems, which function exclusively as passive visualization tools requiring human interpretation before any downstream action is taken. In the present system, the active analytics interface 530 operates as a live input layer to the closed loop, autonomously classifying user behavioral states and emitting predictive triggers that cause the AI decisioning engine 540 to determine and dispatch messaging actions without human intervention, while simultaneously rendering aggregated data to an operator-facing dashboard for inspection and configuration purposes.

The active analytics interface 530 receives two categories of inbound data. Identity-linked activity signals 510 flow into the active analytics interface 530 from the event ingestion engine, carrying normalized transaction event data associated with individual persistent user identity profiles. Messaging interaction data 520 flows in from the messaging gateway, reflecting the engagement history of users with previously transmitted messages including opens, clicks, conversions, and non-responses. Both data streams are received continuously and processed together, such that the behavioral state classifications produced by the active analytics interface 530 reflect the full picture of a user's transaction and engagement history rather than either stream in isolation.

Within the active analytics interface 530, the aggregation layer 521 receives the identity-linked activity signals 510 and messaging interaction data 520 and produces per-user and per-cohort aggregates including purchase frequency summaries, basket size distributions, product-level purchase cadences, promotion response rates, and messaging engagement metrics. These aggregates are passed to the behavioral-state classifier 522, which applies classification logic to assign each user to one or more behavioral states drawn from an enumerated taxonomy including purchase-occurrence, approaching-depletion, offer-responsive, at-risk, and lapsed. The behavioral-state classifier 522 may be implemented as a rules engine, a machine learning classifier, or a combination of the two, and operates continuously as new identity-linked activity signals 510 and messaging interaction data 520 are received, such that a user's classified behavioral state evolves in near-real-time as their transaction and engagement behavior changes.

The output of the behavioral-state classifier 522 is consumed in parallel by two distinct components: the active-trigger emitter 523 and the visualization layer 524. The active-trigger emitter 523 routes classified behavioral states to the AI decisioning engine 540 as predictive triggers, whereupon the AI decisioning engine 540 autonomously determines and dispatches a messaging action corresponding to the classified state. Critically, the active-trigger emitter 523 operates independently of and in parallel with the visualization layer 524, such that predictive triggers are emitted and acted upon regardless of whether any operator is actively viewing the dashboard at the time. This architectural separation is a key distinction of the present system: the path from observed behavioral state to outbound messaging action does not pass through any human-in-the-loop step, eliminating the latency and operational friction that characterize conventional analytics-driven engagement workflows.

The visualization layer 524 renders the aggregated and classified data produced by the aggregation layer 521 and behavioral-state classifier 522 to the operator-facing dashboard 525 for human inspection, configuration, and model-tuning purposes. The operator-facing dashboard 525 provides operators with visibility into user behavioral states, engagement trends, and system performance, and may be used to configure classification thresholds, adjust trigger parameters, and review attribution outcomes. However, as noted, the operator-facing dashboard 525 is a parallel consumer of the data rather than a gate on the active-trigger emitter 523, and its rendering state has no bearing on the autonomous operation of the closed loop. The AI decisioning engine 540 thus receives a continuous stream of predictive triggers from the active-trigger emitter 523 driven entirely by observed user behavior, independently of any operator action or dashboard interaction.

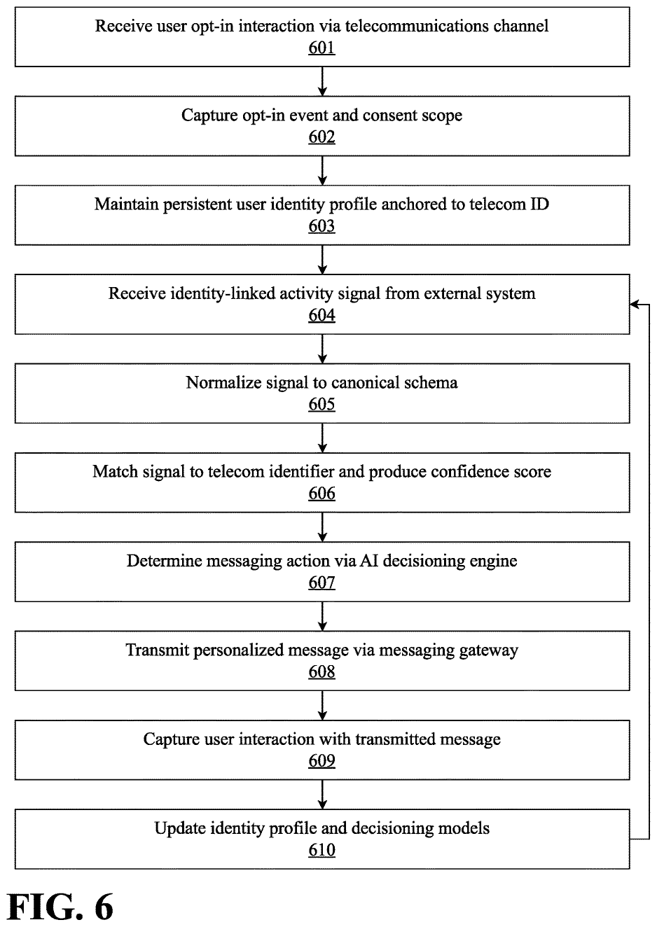

FIG. 6 is a method flow diagram illustrating the master end-to-end closed-loop method for capturing user consent and identity through a telecommunications channel and continuously engaging the identified user based on observed transaction behavior, according to a preferred embodiment. The method depicted represents the complete operational cycle of the system, beginning with the initial capture of a user's consent and telecommunications identifier, proceeding through identity resolution, transaction event ingestion, matchback, AI-driven decisioning, and personalized message dispatch, and closing the loop through feedback propagation that continuously refines the system's understanding of the user and improves the quality of subsequent engagement. The steps of the method are designed to repeat continuously following the initial opt-in, such that each observed transaction event and each captured messaging interaction feeds back into the system and informs future decisioning without requiring any renewed user-provided identity information or manual operator intervention.

The method begins at step 601, in which a user opt-in interaction is received via a telecommunications channel. This interaction represents the entry point of the user into the closed-loop system, and may be initiated through a variety of activation surfaces including a quick-response code displayed at a point of sale, an SMS link, an RCS entry point, or a web-based opt-in asset. The opt-in interaction carries a telecommunications identifier, typically a phone number, together with contextual data associated with the interaction session. At step 602, the opt-in event is captured and the consent scope associated with the interaction is recorded, establishing the boundaries within which the system may subsequently ingest transaction signals, perform identity matching, and dispatch messaging actions with respect to this user. The consent scope is maintained as a structured, multi-state record rather than a binary permission flag, permitting granular governance of which categories of transaction events may be ingested and acted upon.

At step 603, a persistent user identity profile anchored to the telecommunications identifier is established and maintained. This profile accumulates, over the lifetime of the user's relationship with the system, a growing record of transaction history, messaging interaction data, inferred behavioral signals, and linked external system identifiers, and serves as the primary data structure against which all subsequent matching, decisioning, and personalization operations are performed. The persistent nature of the telecommunications identifier as the profile anchor is a foundational property of the method, distinguishing it from approaches that rely on ephemeral or degrading identifiers such as cookies or device advertising IDs, and ensuring that the identity profile retains its integrity and continuity across sessions, devices, and regulatory changes.

At step 604, one or more identity-linked activity signals are received from one or more external transaction systems, representing observable user behavior such as a completed purchase, a cart abandonment, a loyalty event, or a return. These signals may be delivered via webhook, API callback, streaming event subscription, or batch ingestion, depending on the integration surface exposed by the originating external transaction system. At step 605, each received signal is normalized to a canonical schema, translating heterogeneous vendor-specific event formats into a uniform data structure comprising an event type identifier, transaction and ingestion timestamps, source-system and tenant scope identifiers, identity candidates, event payload, attribution metadata, and consent-scope metadata. This normalization step ensures that all downstream matching and decisioning operations can proceed against a consistent data structure regardless of the originating system or event type.

At step 606, each normalized signal is matched to the telecommunications identifier and a confidence score is produced, employing deterministic matching on shared identifiers such as phone number, hashed email address, and loyalty identifier, and probabilistic matching on signals such as device fingerprint, behavioral similarity, and session correlation where deterministic identifiers are unavailable or insufficient. Signals producing a confidence score above a configurable threshold are advanced to downstream decisioning, while signals falling below the threshold are routed to deferred resolution or logging. At step 607, the AI decisioning engine determines a messaging action in response to each matched signal, drawing on the matched signal, the persistent user identity profile, prior messaging interaction data, and the applicable opt-in state to select an action type, determine an optimal dispatch time, select a messaging protocol through the channel eligibility service, and assemble appropriate message content and format.

At step 608, a personalized message corresponding to the determined messaging action is transmitted to the user via the messaging gateway, using the messaging protocol selected by the channel eligibility service. The message may take the form of a personalized offer, a replenishment reminder, a cross-sell prompt, an abandoned-cart recovery message, a loyalty notification, or any other content type appropriate to the triggering event and the user's current behavioral state, and may be delivered via Rich Communication Services or Short Message Service depending on device and carrier eligibility. At step 609, user interaction with the transmitted message is captured, including opens, clicks, suggested reply selections, and any resulting transaction activity observable through connected external transaction systems. At step 610, the persistent user identity profile and the decisioning models governing the AI decisioning engine are updated based on the captured user interaction and on any subsequent identity-linked activity signals received from external transaction systems within the applicable attribution window. The method then returns to step 604, forming a visually and operationally closed loop in which each completed cycle of transaction observation, matching, decisioning, dispatch, and feedback propagation leaves the system better positioned to engage the user effectively in the next cycle.

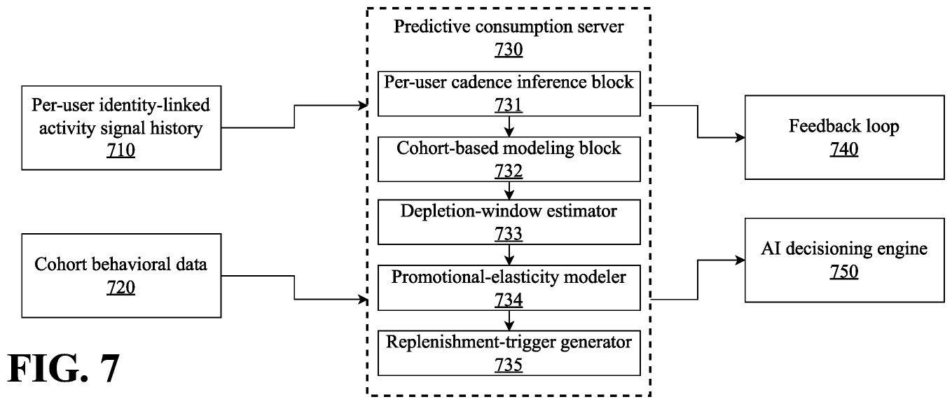

FIG. 7 is a block diagram illustrating the internal architecture of the predictive consumption server and its relationship to the AI decisioning engine and feedback loop, according to an embodiment. The predictive consumption server 730 addresses a deficiency common to existing customer engagement systems, which do not, in the general case, infer per-user product or service depletion windows from observed transaction histories, tie those inferred windows to a persistent telecommunications identifier, and autonomously trigger a corresponding outbound message sized to the projected depletion event. By operating continuously on accumulated identity-linked activity signal histories, the predictive consumption server 730 enables the system to engage users proactively at moments of anticipated need rather than reactively in response only to observed events, representing a qualitatively distinct mode of engagement from the event-triggered messaging described in the preceding figures.

The predictive consumption server 730 receives two categories of inbound data. The per-user identity-linked activity signal history 710 comprises the accumulated sequence of normalized transaction event signals associated with a given persistent user identity profile, drawn from the identity management service and reflecting the full history of observable purchase and engagement behavior for that user at the product or product-family level. The cohort behavioral data 720 comprises population-level consumption models maintained across users sharing observable characteristics such as geographic region, demographic proxies, and inferred behavioral segments, and serves as a source of prior estimates for users whose individual transaction histories are insufficient to support reliable per-user cadence inference on their own. Together, these two input streams provide the predictive consumption server 730 with both the individual-level signal fidelity needed for precise per-user modeling and the population-level coverage needed to handle users at earlier stages of their relationship with the system.

Within the predictive consumption server 730, the per-user cadence inference block 731 analyzes the sequence of purchase-completed and related identity-linked activity signals associated with a given persistent user identity profile, at the product or product-family level, to infer characteristic inter-purchase intervals. In various embodiments, the per-user cadence inference block 731 employs statistical techniques including exponential smoothing, autoregressive integrated moving-average modeling, survival analysis with time-varying covariates, hidden Markov models, and point-process models with user-specific intensity functions. The cohort-based modeling block 732 maintains the population-level consumption models derived from the cohort behavioral data 720, updated continuously from the aggregate flow of identity-linked activity signals across all users, and supplies cohort-based priors to the per-user cadence inference block 731 for users with sparse individual histories and as complementary signals for users with moderate histories.

The depletion-window estimator 733 combines the outputs of the per-user cadence inference block 731 and the cohort-based modeling block 732 to produce, for each user-product pair, an estimated depletion window comprising a central projected depletion time and a confidence interval around that time. The depletion-window estimator 733 operates across a broad range of consumable product and service classes, including food and beverage consumables, household and personal-care consumables, refillable prescriptions, routine automotive service intervals, subscription renewals, and scheduled deliveries. The promotional-elasticity modeler 734 estimates, per user or per cohort, the responsiveness of transaction behavior to prior messaging interactions, correlating messaging interactions delivered through the messaging gateway with subsequent identity-linked activity signals observed within configured response windows to produce estimated incremental effects of messaging on transaction frequency, basket size, and promotional code redemption. These elasticity estimates are supplied as inputs to the AI decisioning engine 750, informing the timing, content type, and channel selection for subsequent messaging actions on a per-user basis.

The replenishment-trigger generator 735 is the output component of the predictive consumption server 730, and is responsible for translating the depletion window estimates produced by the depletion-window estimator 733 into concrete predictive triggers emitted to the AI decisioning engine 750 at configured lead times before the central projected depletion time. Each emitted trigger carries the triggering user's telecommunications identifier, the predicted-depletion product or service, the projected depletion window, and a recommended content class such as a replenishment reminder, a cross-sell prompt for a complementary product, or a loyalty-tier-aware offer. The lead time at which the replenishment-trigger generator 735 emits a given trigger may be set globally per product category or learned per user from observed responsiveness to historical replenishment reminders, such that the timing of proactive engagement is itself a personalized parameter refined over time.

The feedback loop 740 returns observed outcomes from the messaging gateway and from subsequently received identity-linked activity signals back into the predictive consumption server 730, propagating attribution data into the per-user cadence inference block 731 and the promotional-elasticity modeler 734 so that both per-user cadence estimates and elasticity models are continuously updated as new purchase and engagement behavior is observed. This feedback connection ensures that the predictive consumption server 730 does not operate on static models but rather on continuously evolving representations of each user's consumption behavior and promotional responsiveness. The AI decisioning engine 750 receives predictive triggers from the replenishment-trigger generator 735 and processes them through the same action selection, timing optimization, channel selection, and content assembly pipeline used for event-triggered messaging actions, ensuring that proactively triggered replenishment messages are subject to the same confidence gating, opt-in scope enforcement, and personalization logic as all other outbound messaging actions generated by the system.

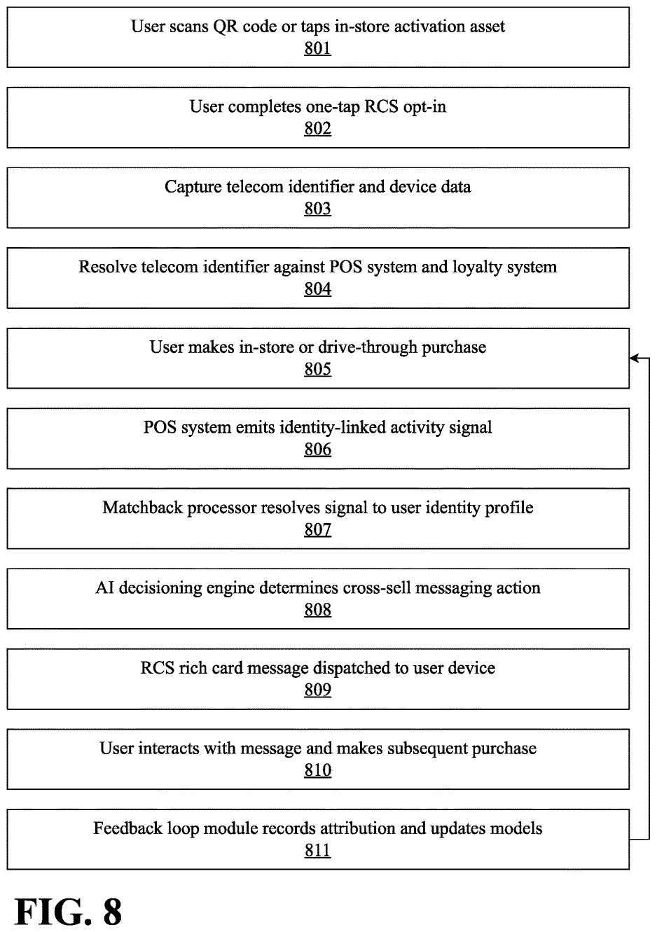

FIG. 8 is a method flow diagram illustrating an example end-to-end flow of the closed-loop customer engagement system in a quick-service restaurant context, according to an embodiment. The quick-service restaurant vertical is among the most commercially significant contexts for the present invention, given the high transaction frequency, the prevalence of loyalty program infrastructure, the availability of line-item purchase data at the point of sale, and the opportunity for immediate in-visit or post-visit engagement through a telecommunications channel. The flow depicted in FIG. 8 illustrates how the architectural components described in the preceding figures operate together in a concrete commercial scenario, from the initial capture of a user's consent and identity through the completion of a subsequent purchase driven by a personalized RCS message, and the attribution of that purchase back into the system's decisioning models.

The flow begins at step 801, in which a user scans a quick-response code or taps an in-store activation asset displayed at a restaurant location. The activation asset may be affixed to a counter display, a drive-through menu board, a table tent, a receipt, or any other in-store surface through which the operator has chosen to surface the opt-in opportunity. The activation asset directs the user's device to initiate an RCS messaging session with the operator's messaging channel, presenting the user with a one-tap opt-in prompt. At step 802, the user completes the one-tap RCS opt-in, providing consent for the operator to engage them via the telecommunications channel and, within the applicable consent scope, to ingest and act upon transaction signals associated with their identity. The frictionless nature of the one-tap opt-in mechanism is significant in the quick-service restaurant context, where the user is typically in motion and the available window for capturing consent is brief.

At step 803, the telecom identifier and device data associated with the opt-in interaction are captured by the interaction control server and recorded in the persistent user identity profile. The telecom identifier, typically the user's phone number, becomes the primary anchor of the identity profile from this point forward. At step 804, the telecom identifier is resolved against the operator's POS system and loyalty system, linking the newly captured telecommunications identity to any existing records the operator holds for this user within those external transaction systems. Where a loyalty identifier is available, deterministic matching establishes a high-confidence binding between the telecom identifier and the user's loyalty and transaction history; where no loyalty record exists, the identity graph records the telecom identifier and device data and begins accumulating transaction associations from the point of opt-in forward. This resolution step is foundational to the subsequent operation of the closed loop, as it is the mechanism by which future point-of-sale transactions are connectable to the persistent user identity profile anchored to the telecommunications identifier.

At step 805, the user places and completes an in-store or drive-through purchase at the restaurant location. This purchase is observed by the POS system in the ordinary course of commercial operation. At step 806, the POS system emits an identity-linked activity signal carrying a full line-item payload including menu item identifiers, modifier selections, aggregate transaction amount, promotional modifiers applied, and a channel-of-purchase indicator distinguishing in-store, drive-through, mobile-ordering, and third-party delivery channels. This signal is delivered to the event ingestion engine via webhook or API callback, normalized to the canonical schema, and forwarded to the matchback processor. At step 807, the matchback processor resolves the signal to the user's persistent user identity profile, employing deterministic matching via loyalty identifier or phone number where available, and producing a confidence-scored match result that gates downstream processing. The near-real-time character of this matchback operation is essential in the quick-service restaurant context, where the window for in-visit engagement closes within minutes of the transaction.

At step 808, the AI decisioning engine determines a cross-sell messaging action in response to the matched identity-linked activity signal, drawing on the line-item payload of the triggering signal, the user's accumulated purchase history, inferred preferences derived from prior transactions, and any applicable promotional or loyalty context. The AI decisioning engine selects a complementary menu item or product category for the cross-sell offer, determines that immediate dispatch is appropriate given the in-visit nature of the triggering event, and delegates protocol selection to the channel eligibility service, which confirms Rich Communication Services availability for the user's device. At step 809, an RCS rich card message is assembled by the content and format selector and dispatched to the user device through the messaging gateway, carrying a personalized cross-sell offer with interactive suggested reply buttons and a one-tap engagement mechanism. The message is designed to reach the user while they are still on premises or within a short time of departing, maximizing the relevance and commercial impact of the engagement.

At step 810, the user interacts with the dispatched RCS rich card message and makes a subsequent purchase, either by tapping through to a mobile ordering flow, redeeming an offer at the counter, or returning to the restaurant on a subsequent visit. This subsequent purchase is itself observed by the POS system and emitted as a further identity-linked activity signal, which is ingested, normalized, and matched by the system in the same manner as the original triggering transaction. At step 811, the feedback loop module records attribution of the subsequent purchase to the dispatched RCS message, updates the user's persistent identity profile with the new transaction data, and propagates the attribution outcome into the AI decisioning engine's models and the promotional-elasticity modeler of the predictive consumption server. The method then returns to step 805, forming a continuous closed loop in which each visit, transaction, message, and interaction leaves the system progressively better calibrated to the individual user's preferences, cadences, and responsiveness, and progressively more capable of delivering timely and relevant engagement across the full lifecycle of the customer relationship.

According to another embodiment, the closed-loop customer engagement system described herein operates across a plurality of commercial verticals, each vertical characterized by distinct transaction patterns, consumption cadences, regulatory constraints, and engagement opportunities. While the quick-service restaurant embodiment described in connection with FIG. 8 illustrates the operation of the system in a high-frequency, low-basket-value, in-visit engagement context, the architectural components and operational methods of the system are equally applicable to other commercial verticals exhibiting different transaction and engagement characteristics. The following embodiments illustrate the operation of the system in four additional representative verticals: grocery retail, pharmacy retail, electronic commerce, and automotive service.

In a grocery retail embodiment, the system operates in a context characterized by frequent repeat purchases of consumable products with predictable depletion cycles, high line-item granularity in transaction events, and strong opportunities for replenishment-driven engagement. A user completes an initial opt-in interaction via a quick-response code displayed at checkout or via an in-store activation asset, and the interaction control server captures the user's telecommunications identifier and establishes a persistent user identity profile. The telecommunications identifier is resolved against the operator's point-of-sale system and loyalty system, linking the telecommunications identity to the user's purchase history. As the user makes subsequent grocery purchases, the point-of-sale system emits identity-linked activity signals carrying detailed line-item payloads including product identifiers, quantities, brands, and categories. The matchback processor resolves these signals to the user's persistent identity profile, and the predictive consumption module analyzes the accumulated purchase history at the product and product-family level to infer characteristic inter-purchase intervals for frequently purchased consumables such as milk, eggs, bread, coffee, and household staples. When the depletion-window estimator determines that a user is approaching a projected depletion time for a previously purchased consumable, the replenishment-trigger generator emits a predictive trigger to the artificial-intelligence decisioning engine, which determines and dispatches a replenishment-reminder message via the messaging gateway. The replenishment-reminder message may include a reorder link enabling one-tap replenishment, a digital coupon incentivizing the replenishment transaction, or a personalized product recommendation for a complementary or upgraded item. The feedback loop module captures the user's interaction with the replenishment message and any subsequent purchase transaction, propagating the attribution outcome into the predictive consumption module to refine future depletion-window estimates for that user and product.

In a pharmacy retail embodiment, the system operates in a context characterized by prescription refill cycles, regulatory constraints governing the handling of protected health information, and heightened sensitivity to consent scope and messaging frequency. The interaction control server captures the user's telecommunications identifier and opt-in state through a privacy-preserving opt-in flow that complies with applicable healthcare privacy regulations, and maintains consent-scope metadata indicating which categories of prescription-related and over-the-counter product-related transaction signals may be ingested and acted upon. The event ingestion engine receives identity-linked activity signals from the pharmacy's prescription management system and point-of-sale system, and the normalization engine applies healthcare-specific data handling rules to ensure that protected health information is pseudonymized or suppressed in accordance with the applicable consent scope before the normalized signal proceeds to the matchback processor. The predictive consumption module infers refill windows for prescription medications based on observed fill dates and prescribed day-supply values, and emits refill-reminder triggers to the artificial-intelligence decisioning engine at configured lead times before projected refill dates. The artificial-intelligence decisioning engine determines messaging actions that remind the user of approaching refill deadlines, provide one-tap refill initiation, and present related over-the-counter product recommendations where such recommendations are within the applicable consent scope. The regulatory-consent layer governing the pharmacy embodiment ensures that all messaging actions comply with applicable healthcare marketing restrictions and that opt-out requests are propagated with enhanced priority and completeness.

In an electronic commerce embodiment, the system operates in a context characterized by session-based shopping behavior, cart abandonment as a frequent observable event, and opportunities for session-continuity-preserving engagement. A user completes an opt-in interaction via a web-based activation asset or SMS link presented during a shopping session, and the interaction control server captures the telecommunications identifier and device data associated with the session. The event ingestion engine receives identity-linked activity signals from the e-commerce platform reflecting cart-addition, cart-modification, session-timeout, and cart-abandonment events, and the matchback processor resolves these signals to the user's persistent identity profile using session correlation and device fingerprint matching in addition to deterministic identifier matching. When a cart-abandonment event is observed, the abandoned-cart recovery handler within the artificial-intelligence decisioning engine determines a messaging action that presents the user with the content of the abandoned cart, provides a frictionless return path to complete the interrupted transaction via a session-restoring deep link, and optionally presents a promotional incentive calibrated to the basket value and the user's historical promotional responsiveness. The messaging gateway transmits the abandoned-cart recovery message via Rich Communication Services where available, leveraging rich card presentation to display cart contents with product images and interactive completion buttons. The feedback loop module tracks the user's interaction with the recovery message and any subsequent purchase completion, attributing successful conversions to the recovery messaging action and propagating the attribution outcome into the decisioning models to refine future recovery timing and incentive strategies.

In an automotive service embodiment, the system operates in a context characterized by periodic service intervals, infrequent but high-value transactions, and opportunities for predictive maintenance-driven engagement. A user completes an opt-in interaction at the conclusion of a service visit, and the interaction control server captures the telecommunications identifier and resolves it against the service provider's customer records and vehicle service history. The event ingestion engine receives identity-linked activity signals from the service provider's shop management system reflecting completed service transactions with associated vehicle identifiers, mileage readings, and service-type classifications. The predictive consumption module analyzes the accumulated service history to infer characteristic service intervals based on calendar time, mileage accumulation rates, and service-type-specific interval standards, and emits maintenance-reminder triggers to the artificial-intelligence decisioning engine at computed lead times before projected service dates. The artificial-intelligence decisioning engine determines messaging actions that remind the user of approaching service milestones, provide service scheduling links, and present relevant seasonal maintenance recommendations such as tire changes or battery testing. The feedback loop module tracks service appointment scheduling and completion following each maintenance-reminder message, propagating attribution outcomes into the predictive consumption module to refine future service-interval estimates and timing optimization for that user and vehicle.

### Exemplary Computing Environment

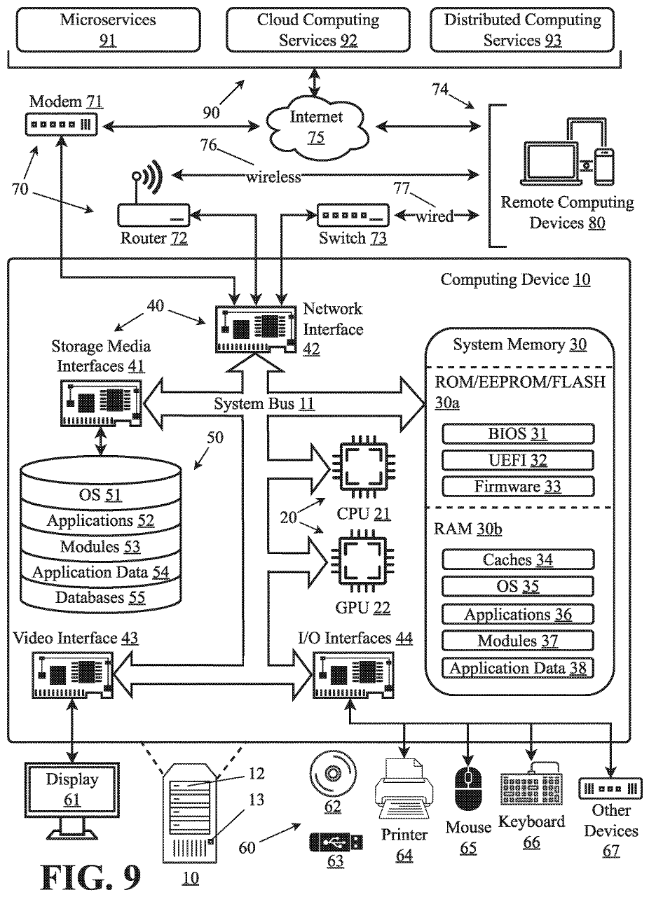

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for capturing user consent and identity through telecommunications channels, comprising:
an interaction control server configured to:
receive a user opt-in interaction via a telecommunications channel;
capture a telecommunications identifier associated with the interaction;
maintain a persistent user identity profile anchored to the telecommunications identifier; and
maintain opt-in state information governing messaging eligibility and transaction-signal-ingestion scope;
an event ingestion engine configured to receive one or more identity-linked activity signals from one or more external transaction systems and normalize the received signals into a canonical schema;
a matchback processor configured to:
associate each received identity-linked activity signal with the telecommunications identifier using one or more of deterministic matching and probabilistic matching; and
produce a confidence score for each matched signal;
an artificial-intelligence decisioning engine configured to determine, in response to each matched identity-linked activity signal, a messaging action based at least in part on the matched identity-linked activity signal, the persistent user identity profile, and the opt-in state information;
a messaging gateway configured to transmit a personalized message corresponding to the determined messaging action via a selected messaging protocol; and
a feedback loop service configured to:
capture user interaction with the transmitted message; and
update the persistent user identity profile and one or more models of the artificial-intelligence decisioning engine based on the captured interaction and on subsequent identity-linked activity signals;
wherein the system operates continuously such that the persistent user identity profile and one or more parameters governing subsequent messaging actions evolve over time without requiring renewed user-provided identity information.

2. The system of claim 1, wherein the matchback processor performs deterministic matching using one or more of a telephone number, a hashed electronic mail address, a loyalty identifier, a tokenized payment credential, and a tokenized customer identifier, and performs probabilistic matching using one or more of a device fingerprint, a behavioral similarity score, a temporal-spatial correlation, and a session correlation.

3. The system of claim 1, wherein the event ingestion engine receives identity-linked activity signals via one or more of a webhook receiver, an application programming interface callback adapter, a streaming event subscriber, and a batch ingestion pathway.

4. The system of claim 1, wherein the artificial-intelligence decisioning engine further comprises a next-best-action selector, a timing optimizer, a channel selector, a content and format selector, and a confidence threshold gate governing autonomous dispatch.

5. The system of claim 1, further comprising a predictive consumption module configured to infer, from a history of identity-linked activity signals associated with the telecommunications identifier, a depletion window or renewal window for a product or service previously acquired by the user, and to cause the artificial-intelligence decisioning engine to determine and dispatch a replenishment-related messaging action at a time computed from the inferred window.

6. The system of claim 5, wherein the predictive consumption module further comprises a promotional-elasticity modeler configured to estimate the responsiveness of transaction behavior to prior messaging interactions, and to supply estimated elasticity as an input to the artificial-intelligence decisioning engine for timing, content, and channel selection of subsequent messaging actions.

7. The system of claim 1, further comprising an active analytics interface configured to aggregate data derived from messaging interactions and identity-linked activity signals, classify users into behavioral states, and emit predictive triggers to the artificial-intelligence decisioning engine autonomously and independently of rendering to any operator-facing dashboard.

8. The system of claim 1, wherein the messaging gateway supports one or more of Short Message Service, Multimedia Messaging Service, and Rich Communication Services, and wherein the personalized message transmitted via Rich Communication Services comprises one or more of a rich card, a carousel, embedded video content, a suggested reply, and an interactive button.

9. The system of claim 1, wherein the opt-in state information governs ingestion of identity-linked activity signals at an event-category granularity, such that event categories outside the applicable consent scope are not ingested, matched, or acted upon.

10. The system of claim 1, wherein the persistent user identity profile is scoped across multiple locations affiliated with a common operator, such that identity-linked activity signals originating at any affiliated location are matched to a single persistent user identity profile anchored to the telecommunications identifier.

11. A method for capturing user consent and identity through telecommunications channels, comprising the steps of:
receiving a user opt-in interaction via a telecommunications channel, using an interaction control server;
capturing a telecommunications identifier associated with the interaction, using an interaction control server;
maintaining a persistent user identity profile anchored to the telecommunications identifier, using an interaction control server;
maintaining opt-in state information governing messaging eligibility and transaction-signal-ingestion scope, using an interaction control server;
receiving one or more identity-linked activity signals from one or more external transaction systems and normalize the received signals into a canonical schema, using an event ingestion engine;
associating each received identity-linked activity signal with the telecommunications identifier using one or more of deterministic matching and probabilistic matching, using a matchback processor;
producing a confidence score for each matched signal, using a matchback processor;
determining, in response to each matched identity-linked activity signal, a messaging action based at least in part on the matched signal, the persistent user identity profile, and the opt-in state information, using an artificial-intelligence decisioning engine;
transmitting a personalized message corresponding to the determined messaging action via a selected messaging protocol, using a messaging gateway;
capturing user interaction with the transmitted message, using a feedback loop service;
updating the persistent user identity profile and one or more models of the artificial-intelligence decisioning engine based on the captured interaction and on subsequent identity-linked activity signals, using a feedback loop service; and
wherein the persistent user identity profile and one or more parameters governing subsequent messaging actions evolve over time without requiring renewed user-provided identity information.

12. The method of claim 11, wherein the deterministic matching uses one or more of a telephone number, a hashed electronic mail address, a loyalty identifier, a tokenized payment credential, and a tokenized customer identifier, and the probabilistic matching uses one or more of a device fingerprint, a behavioral similarity score, a temporal-spatial correlation, and a session correlation.

13. The method of claim 11, wherein the one or more identity-linked activity signals are received via one or more of a webhook receiver, an application programming interface callback adapter, a streaming event subscriber, and a batch ingestion pathway.

14. The method of claim 11, wherein the determining of the messaging action comprises:
selecting a next-best action;
determining a dispatch time for the selected action;
selecting a messaging channel;
selecting message content and a format; and
applying a confidence threshold governing autonomous dispatch, using the artificial-intelligence decisioning engine.

15. The method of claim 11, further comprising the steps of:
inferring, from a history of identity-linked activity signals associated with the telecommunications identifier, a depletion window or renewal window for a product or service previously acquired by the user, using a predictive consumption module; and
causing the artificial-intelligence decisioning engine to determine and dispatch a replenishment-related messaging action at a time computed from the inferred window, using the predictive consumption module.

16. The method of claim 15, further comprising the steps of:
estimating a responsiveness of transaction behavior to prior messaging interactions; and
supplying the estimated responsiveness as an input to the artificial-intelligence decisioning engine for timing, content, and channel selection of subsequent messaging actions, using a promotional-elasticity modeler of the predictive consumption module.

17. The method of claim 11, further comprising the steps of:
aggregating data derived from messaging interactions and identity-linked activity signals, using an active analytics interface;
classifying users into behavioral states, using the active analytics interface; and
emitting predictive triggers to the artificial-intelligence decisioning engine autonomously and independently of rendering to any operator-facing dashboard, using the active analytics interface.

18. The method of claim 11, wherein the selected messaging protocol is one of Short Message Service, Multimedia Messaging Service, and Rich Communication Services, and wherein the personalized message, when transmitted via Rich Communication Services, comprises one or more of a rich card, a carousel, embedded video content, a suggested reply, and an interactive button.

19. The method of claim 11, wherein the opt-in state information governs ingestion of the one or more identity-linked activity signals at an event-category granularity, and wherein identity-linked activity signals corresponding to event categories outside the applicable consent scope are not ingested, matched, or acted upon.

20. The method of claim 11, wherein the persistent user identity profile is scoped across multiple locations affiliated with a common operator, such that identity-linked activity signals originating at any affiliated location are matched to a single persistent user identity profile anchored to the telecommunications identifier.
